(19) United States
(12) Patent Application Publication
(10) Pub. No.: US 2015/0084829 A1
(43) Pub. Date: Mar. 26, 2015

(54) MULTIPLE ANTENNA SYSTEM FOR A WIRELESS DEVICE

(71) Applicant: QUALCOMM Incorporated, San Diego, CA (US)

(72) Inventors: Jatupum Jenwatanavet, San Diego, CA (US); Leif Arvid Woodahl, Poway, CA (US); Jeffrey Joseph Vaccaro, Encinitas, CA (US); Jon Charles Hubbard, Carlsbad, CA (US)

(73) Assignee: QUALCOMM Incorporated, San Diego, CA (US)

(21) Appl. No.: 14/281,410

(22) Filed: May 19, 2014

Related U.S. Application Data
(60) Provisional application No. 61/880,397, filed on Sep. 20, 2013.

(51) Int. Cl. H01Q 3/24; H01Q 1/24

(52) U.S. Cl. CPC H01Q 3/24; H01Q 1/243
USPC 343/876

(57) ABSTRACT

An apparatus includes a wireless device having a radio frequency (RF) circuit, an omni-directional antenna coupled to the RF circuit, a directional antenna coupled to the RF circuit, and a switch configured to couple at least one of the omni-directional antenna and the directional antenna to an output of the RF circuit.

### RELATED APPLICATION

This application claims priority to, and the benefit of the filing date of, U.S. Provisional Application No. 61/880,397, filed on Sep. 30, 2013, entitled “Multiple Antenna System For A Wireless Device” which is hereby incorporated into this document by reference.

### DESCRIPTION OF THE RELATED ART

Electronic devices, such as portable communication devices, continue to diminish in size. All such portable communication devices use some type of antenna for transmitting and receiving communication signals. Antennas and antenna systems generally fall into two categories, directional antennas and non-directional (also referred to as omni-directional) antennas. As its name implies, a directional antenna is one that exhibits a radiation pattern that is stronger in one direction than in another. An omni-directional antenna is one that exhibits a radiation pattern that is substantially the same regardless of direction. In some operating circumstances, it may be desirable to employ an omni-directional antenna, while in other operating circumstances, it may be desirable to employ a directional antenna.

Integrating a directional antenna and an omni-directional antenna in a single wireless device poses challenges including antenna location, orientation, polarization, and other factors. Further, it is also challenging to integrate into a wireless device switching circuitry that can select between the two antennas.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a block diagram illustrating an embodiment of a multiple antenna system for a wireless device.

FIG. 2 is a block diagram illustrating an alternative embodiment of a multiple antenna system for a wireless device.

FIG. 3 is a block diagram illustrating an alternative embodiment of a multiple antenna system for a wireless device.

FIG. 4 is a block diagram illustrating an alternative embodiment of a multiple antenna system for a wireless device.

FIG. 5 is a block diagram showing an omni-directional antenna and a directional antenna located on a printed wiring board.

FIG. 6 is a diagram showing a surface of the PWB of FIG. 5 on which the first antenna is formed.

FIG. 7 is a diagram showing a surface of the PWB of FIG. 5 on which the second antenna is formed.

FIG. 8 is a dimensioned schematic diagram showing a surface of the PWB of FIG. 5 on which the first antenna is formed.

FIG. 9 is a dimensioned schematic diagram showing a surface of the PWB of FIG. 5 on which the second antenna is formed.

FIG. 10 is a block diagram illustrating an example of a wireless device in which the multiple antenna system for a wireless device can be implemented.

FIG. 11 is a flowchart describing the operation of an exemplary embodiment of the multiple antenna system for a wireless device.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

As used herein, the terms “transducer” and “transducer element” refer to an antenna element that can be stimulated with a feed current to radiate electromagnetic energy, and an antenna element that can receive electromagnetic energy and convert the received electromagnetic energy to a receive current that is applied to receive circuitry.

As used herein, the term “orthogonal” refers to lines, line segments, or electric fields that are perpendicular at their point of intersection.

As used here, the term “orthogonal electric fields” refers to the orientation of two electric fields that are perpendicular to each other.

As used herein, the term “dual polarization” refers to an antenna that generates two electric fields and that has two components that are orthogonal to each other.

As used herein, the term “linear polarization” refers to an electric field vector or magnetic field vector that travels along a given plane along the direction of propagation. The orientation of a linearly polarized electromagnetic wave is defined by the direction of the electric field vector. For example, if the electric field vector is vertical (alternately up and down as the wave travels) the radiation is said to be vertically polarized.

As used herein, the term “circular polarization” refers to an electric field vector that, at a given point in space, describes a circle as time progresses. If the wave is frozen in time, the electric field vector of the wave describes a helix along the direction of propagation.

As used herein, the term “directional antenna” is one that exhibits a radiation pattern that is stronger in one direction than in another.

As used herein, the term “omni-directional antenna” is one that exhibits a radiation pattern that is substantially the same regardless of direction.

The multiple antenna system for a wireless device includes an omni-directional antenna and a directional antenna, and can be incorporated into or used with a communication device, such as, but not limited to, a wireless device referred to as an industrial fixed beacon (iFB), or another wireless device it which it is desirable to have both an omni-directional antenna and a directional antenna.

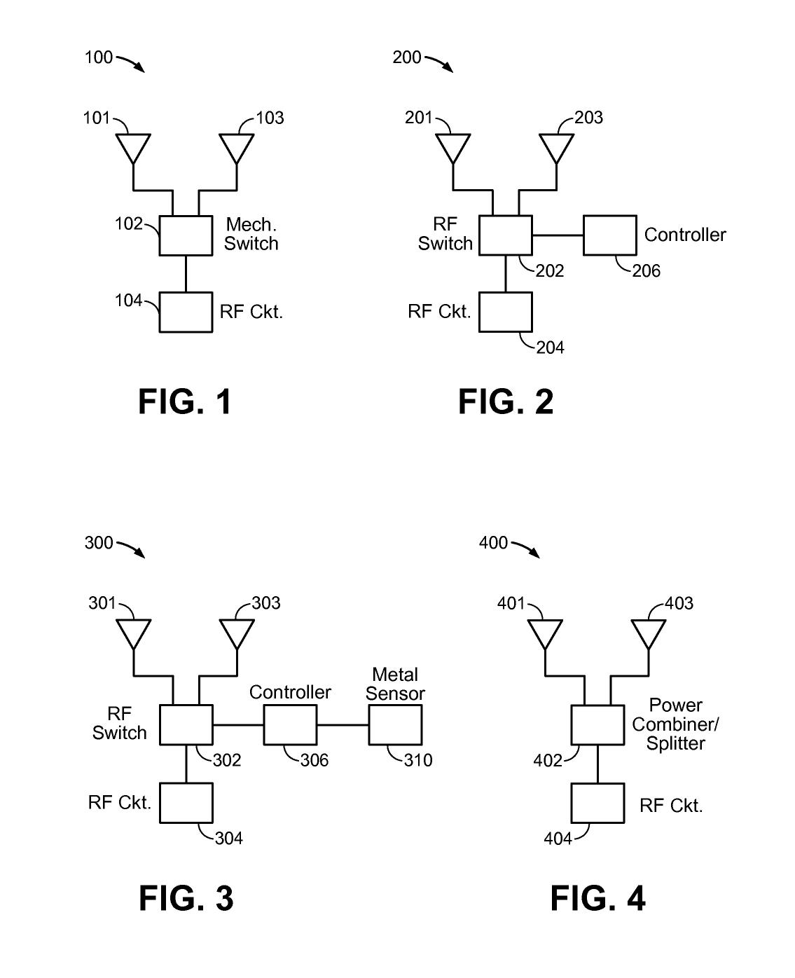

FIG. 1 is a block diagram illustrating an embodiment of a multiple antenna system for a wireless device. The multiple antenna system 100 comprises a first antenna 101, a second antenna 103, a switch 102 and a radio frequency (RF) circuit 104. In this embodiment, the first antenna 101 can be an omni-directional antenna and the second antenna 103 can be a directional antenna. The switch 102 can be a mechanical switch that can be used to manually select between connecting the first antenna 101 to the RF circuit 104, or connecting the second antenna 103 to the RF circuit 104.

FIG. 2 is a block diagram illustrating an alternative embodiment of a multiple antenna system for a wireless device. The multiple antenna system 200 comprises a first antenna 201, a second antenna 203, a switch 202, a radio frequency (RF) circuit 204, and a controller 206. In this embodiment, the first antenna 201 can be an omni-directional antenna and the second antenna 203 can be a directional antenna. The switch 202 can be a radio frequency (RF) switch that can be controlled by the controller 206 to automatically select between connecting the first antenna 201 to the RF circuit 204, or connecting the second antenna 203 to the RF circuit 204 based on a number of different parameters or factors.

FIG. 3 is a block diagram illustrating an alternative embodiment of a multiple antenna system for a wireless device. The multiple antenna system 300 comprises a first antenna 301, a second antenna 303, a switch 302, a radio frequency (RF) circuit 304, a controller 306, and a metal sensor 310. In this embodiment, the first antenna 301 can be an omni-directional antenna and the second antenna 303 can be a directional antenna. The switch 302 can be a radio frequency (RF) switch that can be controlled by the controller 306 to automatically select between connecting the first antenna 301 to the RF circuit 304, or connecting the second antenna 303 to the RF circuit 304 based on a number of different parameters or factors. The metal sensor 310 can determine whether the multiple antenna system 300 is proximate to a metal or a metallic object, and influence the selection of the first antenna 301 or the second antenna 303 accordingly. For example, if the multiple antenna system 300 is not proximate to a metal or metallic object, it may be desirable to employ the first antenna 301. However, if the metal sensor 310 determines that the multiple antenna system 300 is proximate to a metal or a metallic object, then it may be desirable to employ the second antenna 303. An example of a metal sensor 310 can be circuitry that senses the antenna impedance between the first antenna 301 and the RF circuit 304, and/or the antenna impedance between the second antenna 303 and the RF circuit 304. The antenna impedance between the first antenna 301 and the RF circuit 304, and/or the antenna impedance between the second antenna 303 and the RF circuit 304 can be an indicator of whether the multiple antenna system 300 is proximate to a metal or a metallic object. When the antenna is close to a metal object, the metal object will introduce more capacitive coupling to the antenna so that the antenna impedance in the presence of the metal object will have more capacitive reactance (e.g., a greater negative of the imaginary part of the impedance). Those skilled in the art will understand that detecting the impedance can be done using a variety of techniques.

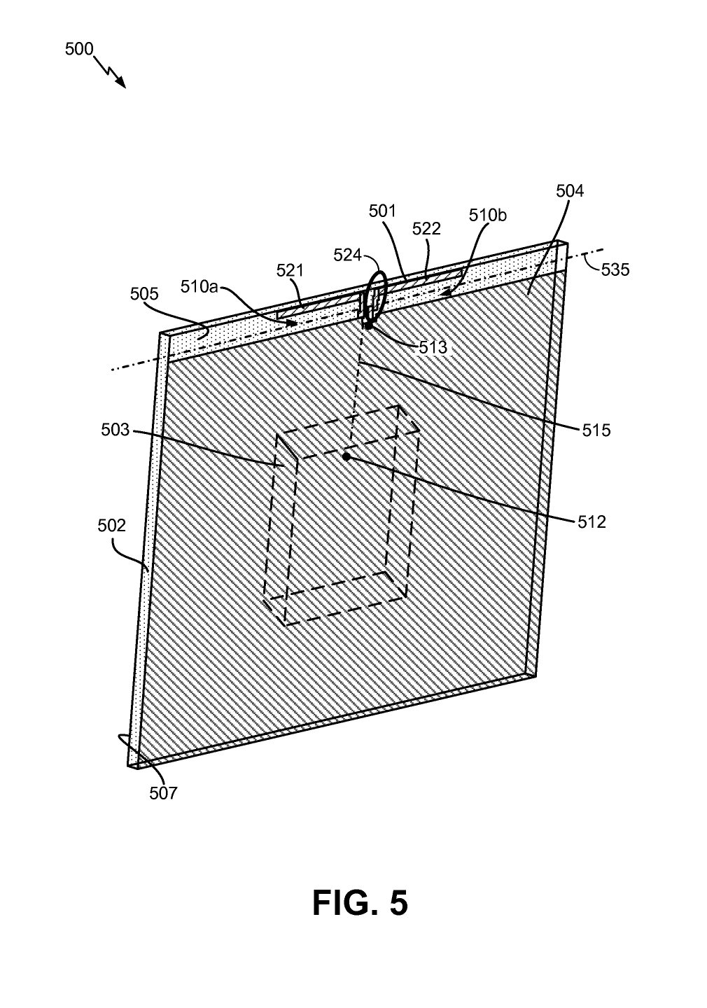

FIG. 4 is a block diagram illustrating an alternative embodiment of a multiple antenna system for a wireless device. The multiple antenna system 400 comprises a first antenna 401, a second antenna 403, a power combiner/splitter 402, and a radio frequency (RF) circuit 404. In this embodiment, the first antenna 401 can be an omni-directional antenna and the second antenna 403 can be a directional antenna. The power combiner/splitter 402 can be used to distribute power between both the first antenna 401, the second antenna 403 and the RF circuit 404 in a way that allows each of the first antenna 401 and the second antenna 403 to operate simultaneously.

FIG. 5 is a block diagram showing an omni-directional antenna and a directional antenna located on a printed wiring board (PWB). In FIG. 5, a printed wiring board 502 includes a surface 505 having a ground plane 504. A first antenna 501 is formed on the surface 505 in the form of a dipole antenna having elements 521 and 522. A second antenna 503 is formed on a surface 507 of the PWB 502 opposite the surface 505 and, in an embodiment, comprises a patch antenna. Both the first antenna 501 and the second antenna 503 can be printed onto one or more surfaces of the PWB 502.

The elements 521 and 522 of the first antenna 501 are located close to the edge of the PWB 502 and form “slots” 510a and 510b located between the elements 521 and 522 and the ground plane 504. The slots 510a and 510b allow the first antenna to operate in what is referred to as a “slot mode.” The first antenna is generally referred to as being “linearly polarized.” However, the “slot mode” operation allowed due to the configuration of the first antenna 501 relative to the ground plane 504 allows the first antenna to exhibit “circular polarization” characteristics, and is considered to be “circularly polarized.” The circular polarization is created when the dipole elements 521 and 522 generate the polarization of the electric field in the axis that is parallel to the orientation of the dipole elements 521 and 522, in this case, it is in the X axis, illustrated using reference numeral 535. Then the slot mode generates the polarization of the electric field in the axis that is vertical to the slot orientation, in this case it is on the Y axis, which is the axis on which the centerline 515 lies. As a result, the two components of the electric field are orthogonal to each other, resulting in the circular polarization. A stepped impedance matching feature 524, which can appear as a “zigzag” feature of the dipole element 522 is also used to control the axial ratio, which is a factor that determines the extent of the circular polarization. The first antenna 501 includes a feed 513 located near the line 515 approximately as shown.

The second antenna 503 is “circularly polarized” and includes a feed 512 also located near the line 515 approximately as shown. Locating the feed 513 of the first antenna 501 and the feed 512 of the second antenna 503 close to each other and close to the line 515 minimizes antenna coupling between the first antenna 501 and the second antenna 503. In an embodiment, the distance between the feed 512 and the feed 513 can be approximately 10 millimeters (mm) to 25 mm.

The first antenna 501 and the second antenna 503 are also formed so as to have respective major surfaces that reside in the same plane, which is also the plane having the major surface of the ground plane 504.

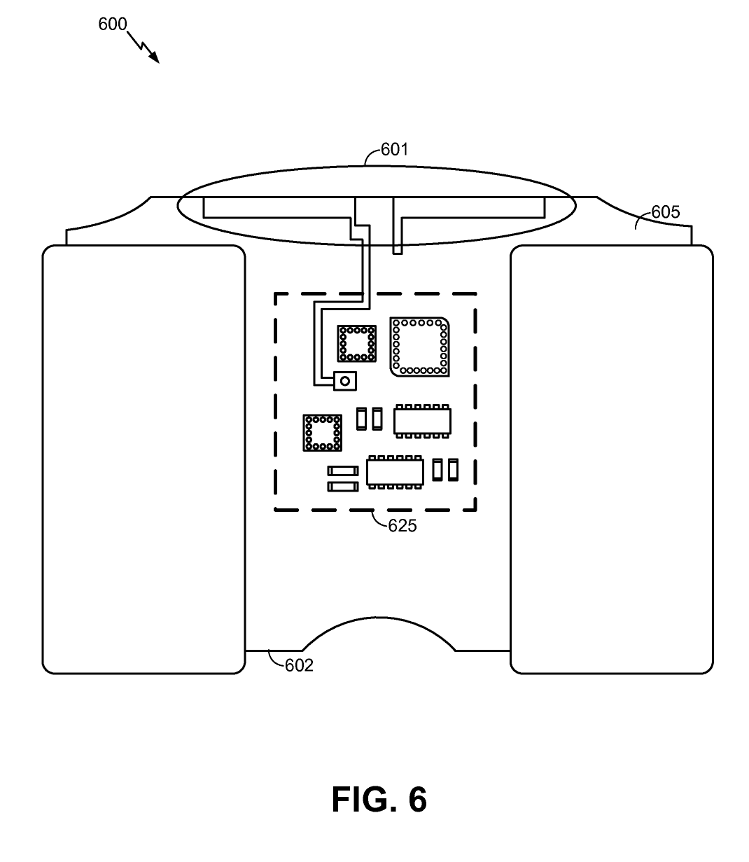

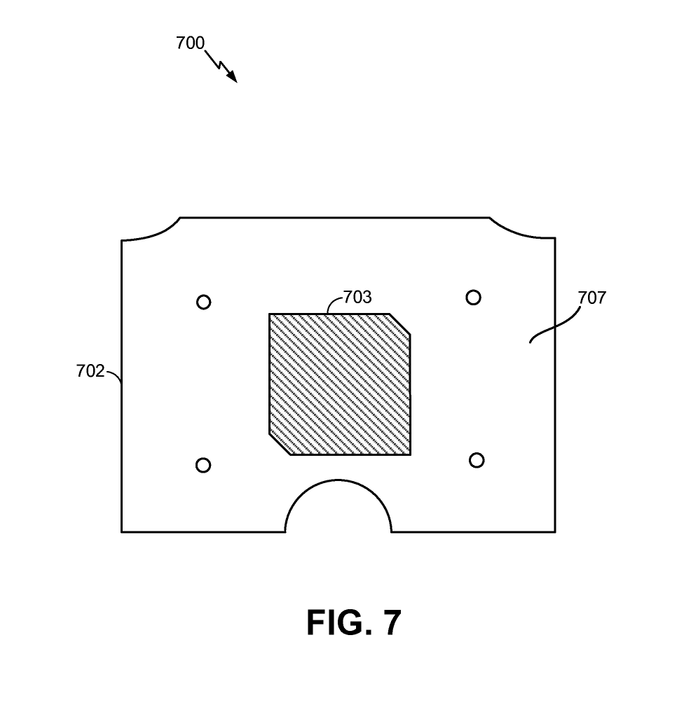

FIG. 6 is a diagram showing a surface of the PWB of FIG. 5 on which the first antenna is formed. In an embodiment, the first antenna 601 is printed on the surface 605 of the PWB 602. Components that comprise a controller 625 can also be located on the surface 605 of the PWB 602.

FIG. 7 is a diagram showing a surface of the PWB of FIG. 5 on which the second antenna is formed. In an embodiment, the second antenna 703 is printed on the surface 707 of the PWB 702. The surface 707 is opposite the surface 605 shown in FIG. 6.

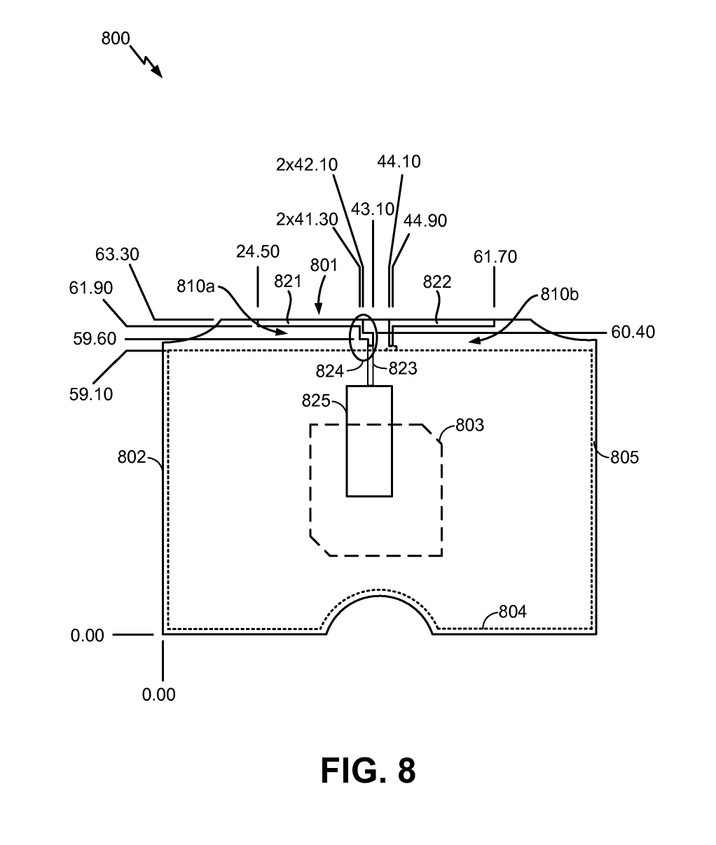

FIG. 8 is a dimensioned schematic diagram showing a surface of the PWB of FIG. 5 on which the first antenna is formed. In an embodiment, the first antenna 801 is printed on the surface 805 of the PWB 802. Components that comprise a controller 825 can also be located in the surface 805 of the PWB 802. The second antenna 803 is illustrated in dotted line to indicate that it is located on a surface opposite the surface 805.

The elements 821 and 822 of the first antenna 801 are located close to the edge of the PWB 802 and form “slots” 810a and 810b located between the elements 821 and 822 and the ground plane 804. The slots 810a and 810b allow the first antenna 801 to operate in what is referred to as a “slot mode.” The first antenna is referred to as being “circularly polarized.” As mentioned above, the circular polarization of the first antenna 801 results from the combination of the slot mode and the ordinary linear polarization of the dipole mode. The circular polarization of the first antenna 801 results from the ordinary single element dipole antenna combined with the hidden “slot mode” operation resulting from the slots 810a and 810b. The circular polarization of the first antenna 801 is created by the orthogonality between the electric field from the slots 810a and 810b and the electric field from the dipole elements 821 and 822.

The first antenna 801 also includes an impedance matching feature 824. In an embodiment the impedance matching feature 824 comprises a “meander” “stepped” or a “zig-zag” structure, which performs antenna impedance matching by creating capacitive and inductive coupling. Controlling the capacitive and inductive coupling for the first antenna 801 allows effective impedance matching for the first antenna 801. The meander pattern of the impedance matching feature 824 contributes to impedance matching because the meander pattern behaves as an inductor, while the gap between the impedance matching feature 824 and the other dipole element 822; and the gap between the impedance matching feature 824 and the ground plane 804 will behave as a capacitor.

Further, the impedance matching feature 824 also influences, to some extent, the axial ratio, which is a factor that determines the degree of circular polarization. The axial ratio depends, at least in part, on the size of the ground plane and the slot gap distance defined between the lower edge of the dipole elements 821 and 822 and the upper edge of the ground plane 804, which in an exemplary embodiment, can be 2.8 mm In an exemplary embodiment, the impedance matching feature 824 will connect directly to a radio frequency(RF) front end circuit in the controller 825 over, for example, connection 823, and the dipole element 822 will connect directly to the ground plane 804.

The dimensions shown in FIG. 8 are all in millimeters (mm) and are exemplary for a particular embodiment. The second antenna 803 is shown in phantom in FIG. 8 for reference.

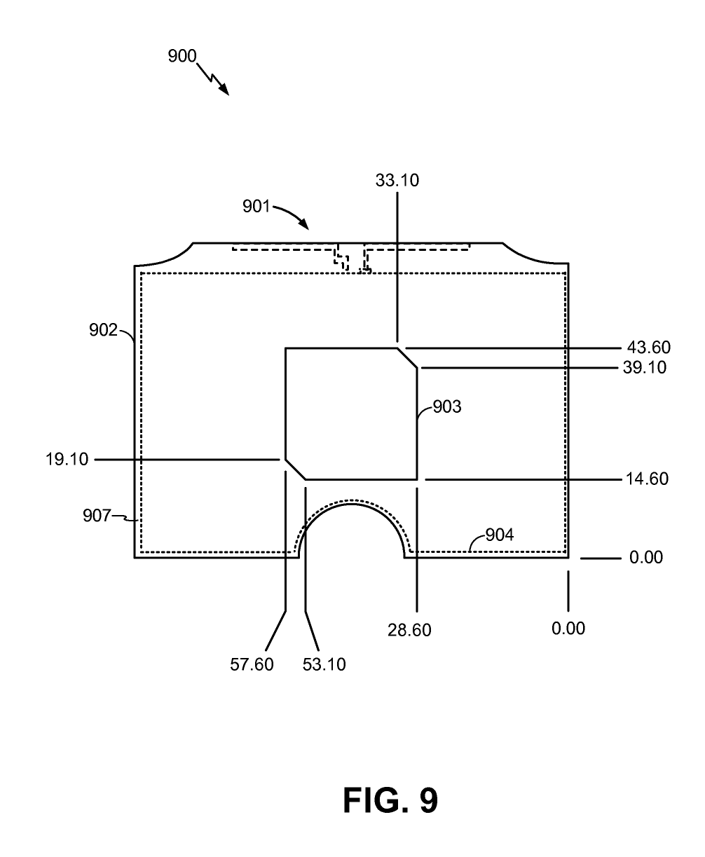

FIG. 9 is a dimensioned schematic diagram showing a surface of the PWB of FIG. 5 on which the second antenna is formed. In an embodiment, the second antenna 903 is printed on the surface 907 of the PWB 902.

The second antenna 903 is printed as shown and is configured to be “circularly polarized.” The dimensions shown in FIG. 9 are all in millimeters (mm) and are exemplary for a particular embodiment. The first antenna 901 is shown in phantom for reference.

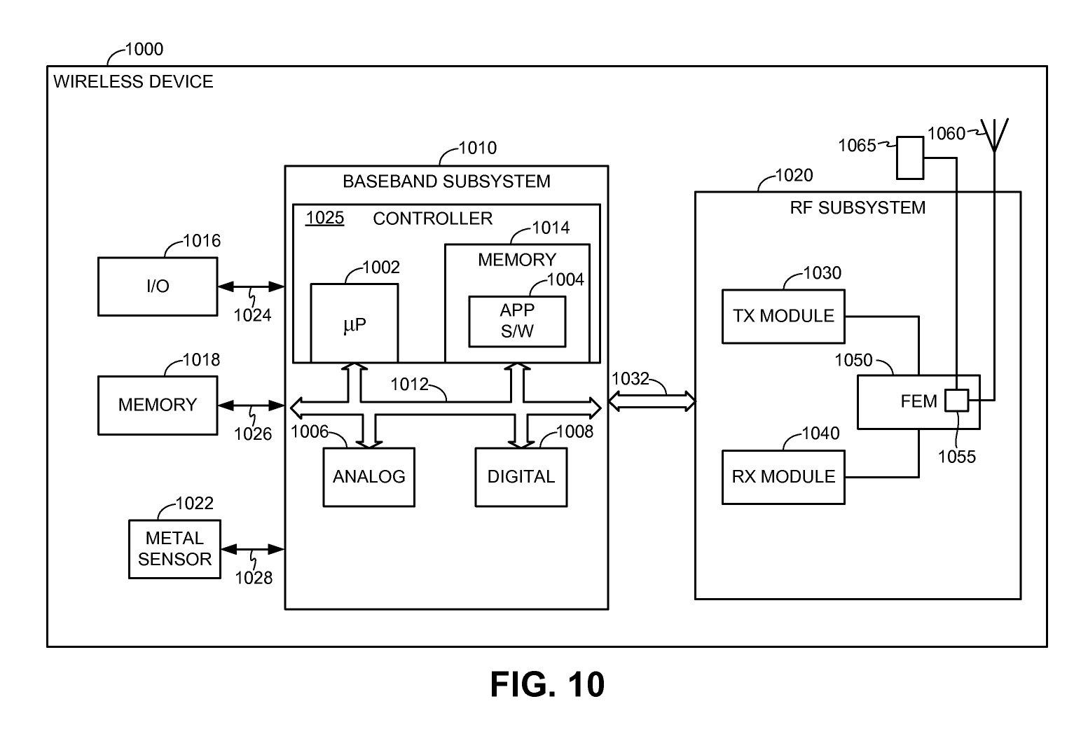

FIG. 10 is a block diagram illustrating an example of a wireless device 1000 in which the multiple antenna system for a wireless device can be implemented. In an embodiment, the wireless device 1000 can be a “Bluetooth” wireless communication device, a portable cellular telephone, a WiFi enabled communication device, or can be any other communication device. Embodiments of the multiple antenna system for a wireless device can be implemented in any communication device. The wireless device 1000 illustrated in FIG. 10 is intended to be a simplified example of an iFB device and to illustrate one of many possible applications in which the multiple antenna system for a wireless device can be implemented. One having ordinary skill in the art will understand the operation of a portable wireless device, and, as such, implementation details are omitted. In an embodiment, the wireless device 1000 includes a baseband subsystem 1010 and an RF subsystem 1020 connected together over a system bus 1032. The system bus 1032 can comprise physical and logical connections that couple the above-described elements together and enable their interoperability. In an embodiment, the RF subsystem 1020 can be a wireless transceiver. Although details are not shown for clarity, the RF subsystem 1020 generally includes a transmit module 1030 having modulation, upconversion and amplification circuitry for preparing and transmitting a baseband information signal, includes a receive module 1040 having amplification, filtering and downconversion circuitry for receiving and downconverting an RF signal to a baseband information signal to recover data, and includes a front end module (FEM) 1050 that includes diplexer circuitry, duplexer circuitry, or any other circuitry that can separate a transmit signal from a receive signal, as known to those skilled in the art. The front end module 1050 also comprises a switch 1055 configured to couple any of a first antenna 1060 and a second antenna 1065 to the FEM 1050. In an exemplary embodiment, the first antenna 1060 can be an omni-directional antenna and the second antenna 1065 can be a directional antenna. The switch 1055 can comprise any of a mechanical switch, a radio frequency (RF) switch, or any other switch that can select any of the first antenna 1060 and the second antenna 1065. The first antenna 1060, the second antenna 1065 and at least a portion of the RF subsystem 1020 can comprise any of the embodiments of the multiple antenna system for a wireless device as described herein. When implemented as shown in FIG. 10, the multiple antenna system for a wireless device can be implemented as part of one or more modules that comprise the RF subsystem 1020.

The baseband subsystem 1010 generally includes a processor 1002, which can be a general purpose or special purpose microprocessor, memory 1014, application software 1004, analog circuit elements 1006, and digital circuit elements 1008, coupled over a system bus 1012. The system bus 1012 can comprise the physical and logical connections to couple the above-described elements together and enable their interoperability.

An input/output (I/O) element 1016 is connected to the baseband subsystem 1010 over connection 1024 and a memory element 1018 is coupled to the baseband subsystem 1010 over connection 1026. The I/O element 1016 can include, for example, a microphone, a keypad, a speaker, a pointing device, user interface control elements, and any other devices or system that allow a user to provide input commands and receive outputs from the wireless device 1000.

The memory 1018 can be any type of volatile or non-volatile memory, and in an embodiment, can include flash memory. The memory 1018 can be permanently installed in the wireless device 1000, or can be a removable memory element, such as a removable memory card.

The wireless device 1000 may also include a metal sensor 1022 coupled to the baseband subsystem 1010 over connection 1028. The metal sensor 1022 can detect the presence of metal or metallic objects in the vicinity of the wireless device 1000 and cause the wireless device 1000 to use one or more of the exemplary embodiments of the directional antenna and the omni-directional antenna described herein. For example, the metal sensor 1022 may provide an impedance measurement that can be interpreted by the processor 1002, which can then control the front end module 1050 to select any of the first antenna 1060 and the second antenna 1065 in response to the signal from the metal sensor 1022. The processor 1002, the memory 1014 and the application software 1004 may comprise a controller 1025, or perform a controller function to control the switch 1055 to select the appropriate antenna based on location, operating conditions, or other factors.

The processor 1002 can be any processor that executes the application software 1004 to control the operation and functionality of the wireless device 1000. The memory 1014 can be volatile or non-volatile memory, and in an embodiment, can be non-volatile memory that stores the application software 1004.

The analog circuitry 1006 and the digital circuitry 1008 include the signal processing, signal conversion, and logic that convert an input signal provided by the I/O element 1016 to an information signal that is to be transmitted. Similarly, the analog circuitry 1006 and the digital circuitry 1008 include the signal processing elements used to generate an information signal that contains recovered information from a received signal. The digital circuitry 1008 can include, for example, a digital signal processor (DSP), a field programmable gate array (FPGA), or any other processing device. Because the baseband subsystem 1010 includes both analog and digital elements, it can be referred to as a mixed signal device (MSD).

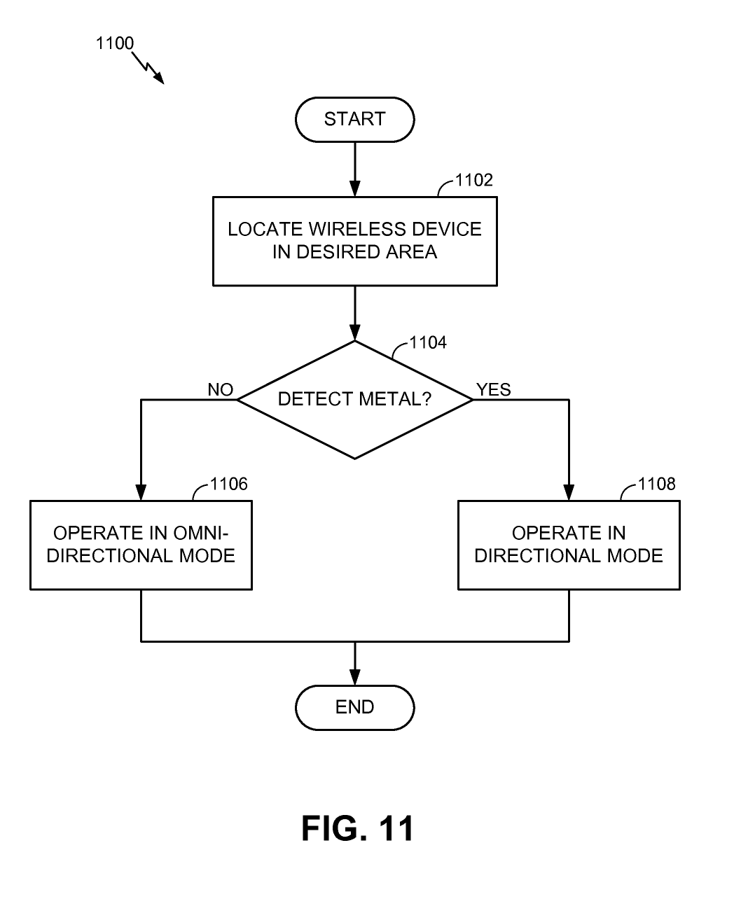

FIG. 11 is a flowchart 1100 describing the operation of an exemplary embodiment of the multiple antenna system for a wireless device. The blocks in the flowchart 1100 can be performed in or out of the order shown.

In block 1102, a wireless device 1000 is located in a particular area. In block 1104, the metal sensor 1022 in the wireless device 1000 determines whether the wireless device 1000 is located in the vicinity of metal or metallic object.

If in block 1104 the metal sensor 1022 in the wireless device 1000 determines that the wireless device 1000 is not located in the vicinity of metal or metallic object, then in block 1106, the controller 1025 causes the switch 1055 to select the first antenna 1060 and operates in an omni-directional mode.

If in block 1104 the metal sensor 1022 in the wireless device 1000 determines that the wireless device 1000 is located in the vicinity of metal or metallic object, then in block 1108, the controller 1025 causes the switch 1055 to select the second antenna 1065 and operates in a directional mode as a result of the wireless device 1000 being located in the presence of metal.

Although selected aspects have been illustrated and described in detail, it will be understood that various substitutions and alterations may be made therein without departing from the spirit and scope of the present invention, as defined by the following claims.

What is claimed is:

1. An apparatus, comprising:
a wireless device having a radio frequency (RF) circuit;
an omni-directional antenna coupled to the RF circuit;
a directional antenna coupled to the RF circuit; and
a switch configured to couple at least one of the omni-directional antenna and the directional antenna to an output of the RF circuit.

2. The apparatus of claim 1, wherein the switch is chosen from a mechanical switch, a radio frequency (RF) switch, and a power combiner/splitter.

3. The apparatus of claim 2, further comprising a controller configured to control the switch.

4. The apparatus of claim 3, further comprising a metal sensor configured to provide an input to the controller such that the controller determines whether an output of the RF circuit is coupled to the omni-directional antenna and the directional antenna.

5. The apparatus of claim 1, wherein the switch is a radio frequency (RF) switch and the antenna system further comprises:
a controller configured to control the RF switch; and
a metal sensor configured to determine whether the antenna system is located in the vicinity of metal.

6. The apparatus of claim 5, wherein the metal sensor causes the controller to select the directional antenna in the presence of metal.

7. The apparatus of claim 1, wherein the omni-directional antenna is a dipole antenna and the directional antenna is a patch antenna.

8. The apparatus of claim 7, wherein a feed for the omni-directional antenna and a feed for the directional antenna are located approximately 10 mm to 25 mm apart on a common line.

9. The apparatus of claim 8, wherein the omni-directional antenna and the directional antenna are printed on a printed wiring board (PWB).

10. The apparatus of claim 9, wherein the omni-directional antenna is printed proximate to an edge of the PWB, thereby creating a slot antenna mode between the omni-directional antenna and a ground plane on the PWB.

11. The apparatus of claim 10, wherein the omni-directional antenna is circularly polarized and the directional antenna is circularly polarized.

12. The apparatus of claim 10, wherein the omni-directional antenna further comprises a stepped impedance matching feature.

13. The apparatus of claim 10, wherein the omni-directional antenna and the directional antenna have respective major surfaces located in a common plane.

14. A method, comprising:
locating a wireless device having a radio frequency (RF) circuit in a particular location;
determining whether the wireless device is located in a vicinity of a metal; and
operating the wireless device in a directional mode when the wireless device is located in the presence of metal.

15. The method of claim 14, further comprising operating the wireless device in an omni-directional mode when the wireless device is located in a location that is free of metal.

16. An apparatus, comprising:
a wireless device having a radio frequency (RF) circuit and a metal sensor;
a first antenna coupled to the RF circuit;
a second antenna coupled to the RF circuit; and
a controller coupled to the RF circuit, the first antenna and the second antenna, the controller configured to select any of the first antenna and the second antenna responsive to a signal from the metal sensor.

17. The apparatus of claim 16, wherein the metal sensor generates a signal representative of whether the wireless device is located in the presence of metal.

18. An apparatus, comprising:
a wireless device having a radio frequency (RF) circuit;
an omni-directional antenna coupled to the RF circuit, the omni-directional antenna comprising a dipole structure having a first dipole element and a second dipole element;
a directional antenna coupled to the RF circuit, the directional antenna comprising a patch antenna; and
a ground plane associated with the RF circuit, the ground plane arranged so as to create a slot mode associated with the first dipole element and the second dipole element,
the first dipole element and the second dipole element generating a first polarization of an electric field in a first axis that is parallel to the orientation of the first dipole element and the second dipole element,
the slot mode causing the omni-directional antenna to generate a second polarization of the electric field in a second axis that is orthogonal to the first axis.

19. The apparatus of claim 18, wherein the two orthogonal components of the electric field create a circular polarization for the omni-directional antenna.

20. The apparatus of claim 19, further comprising a stepped impedance matching feature associated with the omni-directional antenna, the stepped impedance matching feature configured to control a ratio of the first polarization and the second polarization and configured to provide impedance matching between the omni-directional antenna and the RF circuit.
